(19) United States
(12) Patent Application Publication
(10) Pub. No.: US 2026/0070784 A1
(43) Pub. Date: Mar. 12, 2026

(54) HYDROGEN GENERATING DEVICE

(71) Applicant: TOYOTA JIDOSHA KABUSHIKI KAISHA, Toyota-shi (JP)

(72) Inventor: Masahiro IMANISHI, Gotemba-shi (JP)

(21) Appl. No.: 19/294,583

(22) Filed: Aug. 8, 2025

(30) Foreign Application Priority Data
Sep. 6, 2024 (JP) 2024-154157

(51) Int. Cl. C01B 3/06

(52) U.S. Cl. CPC C01B 3/065; C01B 2203/1205; C01B 2203/1657; C01B 2203/169

(57) ABSTRACT

A hydrogen generating device may include a water supply device for cartridges; a first hydrogen supply valve provided in a first hydrogen supply passage through which hydrogen gas is supplied from the first cartridge to a buffer tank; a second hydrogen supply valve provided in a second hydrogen supply passage through which hydrogen gas is supplied from the second cartridge to the buffer tank; and a main hydrogen supply passage for supplying hydrogen gas from the buffer tank to outside. For switching a hydrogen supply source from the first cartridge to the second cartridge, a controller may perform: a first process to stop supplying water to the first cartridge and supply water to the second cartridge with the second hydrogen supply valve closed, and a second process to open the second hydrogen supply valve to supply hydrogen gas from the second cartridge to the buffer tank.

### CROSS REFERENCE TO RELATED APPLICATION

This application claims priority to Japanese Patent Application No. 2024-154157 filed on September 6, 2024. The entire content of the priority application is incorporated herein by reference.

### TECHNICAL FIELD

The technology disclosed herein relates to hydrogen generating devices.

### BACKGROUND

A hydrogen generating device is known that generates hydrogen using a cartridge containing a substance that generates hydrogen gas by reacting with water. For example, Japanese Patent Application Publication No. 2022-068928 describes a hydrogen generating device that uses a cartridge containing a substance (specifically, a catalyst) that generates hydrogen gas by reacting with water (specifically, an aqueous solution). The cartridge is detachably attachable to the hydrogen generating device. The hydrogen generating device generates hydrogen gas by supplying water into the cartridge and supplies the generated hydrogen gas to an external device (e.g., a fuel cell).

### SUMMARY

The hydrogen generating device of Japanese Patent Application Publication No. 2022-068928 has only one cartridge attachment portion, thus the hydrogen generating device cannot be used during replacement of the cartridge. Therefore, the hydrogen generating device of Japanese Patent Application Publication No. 2022-068928 can continuously operate for only a short time. In contrast, a hydrogen generating device is allowed to continuously operate for a longer time by providing the hydrogen generating device with a plurality of cartridge attachment portions and switching the cartridge to be used. This disclosure herein provides a technology for stably supplying hydrogen gas when the cartridge to be used is switched in a hydrogen generating device to which a plurality of cartridges are attachable.

A first hydrogen generating device disclosed herein may comprise a first attachment portion and a second attachment portion to which cartridges are attached, wherein the cartridges contain a substance that generates hydrogen gas when reacting with water; a water supply device conFIG.ured to supply water to a first cartridge attached to the first attachment portion and a second cartridge attached to the second attachment portion; a buffer tank; a first hydrogen supply passage for supplying hydrogen gas from the first cartridge to the buffer tank; a second hydrogen supply passage for supplying hydrogen gas from the second cartridge to the buffer tank; a first hydrogen supply valve conFIG.ured to open and close the first hydrogen supply passage; a second hydrogen supply valve conFIG.ured to open and close the second hydrogen supply passage; a main hydrogen supply passage for supplying hydrogen gas from the buffer tank to outside; and a controller conFIG.ured to control the water supply device, the first hydrogen supply valve, and the second hydrogen supply valve. For switching a hydrogen supply source from the first cartridge to the second cartridge while hydrogen gas is being supplied from the first cartridge to the buffer tank by water is being supplied to the first cartridge and the first hydrogen supply valve being opened, the controller may perform: a first process to stop supplying water to the first cartridge and supply water to the second cartridge with the second hydrogen supply valve closed, and a second process to open the second hydrogen supply valve to supply hydrogen gas from the second cartridge to the buffer tank after the first process.

The “water” in the above expression “a substance that generates hydrogen gas when reacting with water” may be pure water or an aqueous solution.

In the first hydrogen generating device, when the hydrogen supply source is switched from the first cartridge to the second cartridge, water is supplied to the second cartridge with the second hydrogen supply valve closed in the first process. This water supply generates hydrogen gas in the second cartridge. Since the second hydrogen supply valve is closed, the pressure in the second cartridge increases due to the generated hydrogen gas. Then, in the second process, the second hydrogen supply valve is opened to supply the hydrogen gas from the second cartridge to the buffer tank. Since the pressure in the second cartridge is high, the hydrogen gas can be easily supplied from the second cartridge to the buffer tank. Thus, by performing the first and second processes, the hydrogen supply source can be switched from the first cartridge to the second cartridge. In the first process, water supply to the first cartridge is stopped and water is supplied to the second cartridge. Since the water supply to the first cartridge is stopped, the supply of hydrogen gas from the first cartridge to the buffer tank is reduced or stopped after the first process. However, even when the supply of hydrogen gas from the first cartridge to the buffer tank is reduced, hydrogen gas is supplied from the buffer tank to the main hydrogen supply passage by the pressure in the buffer tank. Therefore, this hydrogen generating device can stably supply hydrogen gas even during the switching operation.

A second hydrogen generating device disclosed herein may comprise a first attachment portion and a second attachment portion to which cartridges are attached, wherein the cartridges contain a substance that generates hydrogen gas when reacting with water; a first water supply device conFIG.ured to supply water to a first cartridge attached to the first attachment portion; a second water supply device conFIG.ured to supply water to a second cartridge attached to the second attachment portion; a main hydrogen supply passage for supplying hydrogen gas to outside; a first hydrogen supply passage for supplying hydrogen gas from the first cartridge to the main hydrogen supply passage; a second hydrogen supply passage for supplying hydrogen gas from the second cartridge to the main hydrogen supply passage; a first hydrogen supply valve conFIG.ured to open and close the first hydrogen supply passage; a second hydrogen supply valve conFIG.ured to open and close the second hydrogen supply passage; and a controller conFIG.ured to control the first water supply device, the second water supply device, the first hydrogen supply valve, and the second hydrogen supply valve. For switching a hydrogen supply source from the first cartridge to the second cartridge while hydrogen gas is being supplied from the first cartridge to the main hydrogen supply passage by water is being supplied to the first cartridge and the first hydrogen supply valve being opened, the controller may perform: a first process to supply water to the second cartridge with the second hydrogen supply valve closed while supplying water to the first cartridge and keeping the first hydrogen supply valve opened, and a second process to open the second hydrogen supply valve to supply hydrogen gas from the second cartridge to the main hydrogen supply passage and close the first hydrogen supply valve after the first process.

The “water” in the above expression “a substance that generates hydrogen gas when reacting with water” may be pure water or an aqueous solution.

In the second hydrogen generating device, when the hydrogen supply source is switched from the first cartridge to the second cartridge, water is supplied to the second cartridge with the second hydrogen supply valve closed in the first process. This water supply generates hydrogen gas in the second cartridge. Since the second hydrogen supply valve is closed, the pressure in the second cartridge increases due to the generated hydrogen gas. Then, in the second process, the second hydrogen supply valve is opened to supply the hydrogen gas from the second cartridge to the main hydrogen supply passage. Since the pressure in the second cartridge is high, the hydrogen gas can be easily supplied from the second cartridge to the main hydrogen supply passage. In the second process, the first hydrogen supply valve is closed to stop the supply of hydrogen gas from the first cartridge to the main hydrogen supply passage. Thus, by performing the first and second processes, the hydrogen supply source can be switched from the first cartridge to the second cartridge. In the first process, water is supplied to the first cartridge and the first hydrogen supply valve is kept open. In other words, in the first process, the supply of hydrogen gas from the first cartridge to the main hydrogen supply passage is maintained. Therefore, this hydrogen generating device can stably supply hydrogen gas during the switching operation.

### BRIEF DESCRIPTION OF DRAWINGS

FIG. 1 is a perspective view of a hydrogen generating device.

FIG. 2 shows passages for hydrogen gas and water in a hydrogen generating device according to a first embodiment.

FIG. 3 shows passages for hydrogen gas and water in each stage of the hydrogen generating device according to the first embodiment.

FIG. 4 is a flowchart of a switching process in the first embodiment.

FIG. 5 shows passages for hydrogen gas and water in a hydrogen generating device according to a second embodiment.

FIG. 6 shows passages for hydrogen gas and water in each stage of the hydrogen generating device according to the second embodiment.

FIG. 7 is a flowchart of a switching process in the second embodiment.

### DETAILED DESCRIPTION

In the first hydrogen generating device, the controller may perform the first process while keeping the first hydrogen supply valve opened and close the first hydrogen supply valve after the first process.

This configuration allows hydrogen gas to be supplementally supplied from the first cartridge to the buffer tank during the first process. Therefore, this hydrogen generating device can supply hydrogen gas more stably during the switching operation.

In the first hydrogen generating device, the controller may perform a process to increase an amount of water supplied to the first cartridge to increase a pressure inside the first cartridge before the first process.

This configuration allows hydrogen gas to be supplied more stably from the first cartridge to the buffer tank during the first and second processes.

The first hydrogen generating device may further comprise a purge valve configured to open and close a flow passage that opens the second cartridge to outside air. In the first process, the controller may open the purge valve to perform a purge of the second cartridge and close the purge valve after the purge to increase a pressure inside the second cartridge.

The second cartridge before use is filled with a fill gas (e.g., inert gas) different from hydrogen gas. Since the above hydrogen generating device can discharge the fill gas from the second cartridge to the outside by the purge, the supply of fill gas to the buffer tank can be prevented.

The second hydrogen generating device may further comprise a purge valve configured to open and close a flow passage that opens the second cartridge to outside air. In the first process, the controller may open the purge valve to perform a purge of the second cartridge and close the purge valve after the purge to increase a pressure inside the second cartridge.

Since the above hydrogen generating device can discharge the fill gas from the second cartridge to the outside by the purge, the supply of fill gas to the main hydrogen supply passage can be prevented.

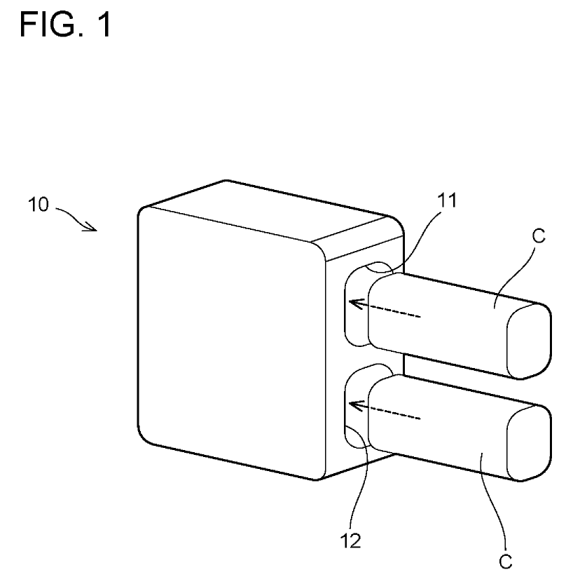

(First Embodiment) As shown in FIG. 1, a hydrogen generating device 10 according to a first embodiment has a first slot hole 11 and a second slot hole 12 defined in its side surface. Cartridges C can be attached to the hydrogen generating device 10 by being inserted into the slot holes 11 and 12. Each cartridge C is a sort of reaction container and contains a hydrogen-generating agent inside. The hydrogen-generating agent is a substance that generates hydrogen gas (i.e., H₂) when reacting with water. In this embodiment, the hydrogen-generating agent is sodium borohydride. The cartridges C are detachably attachable to the slot holes 11 and 12. Hereafter, a cartridge attached to the first slot hole 11 is referred to as a cartridge C1 and a cartridge attached to the second slot hole 12 is referred to as a cartridge C2.

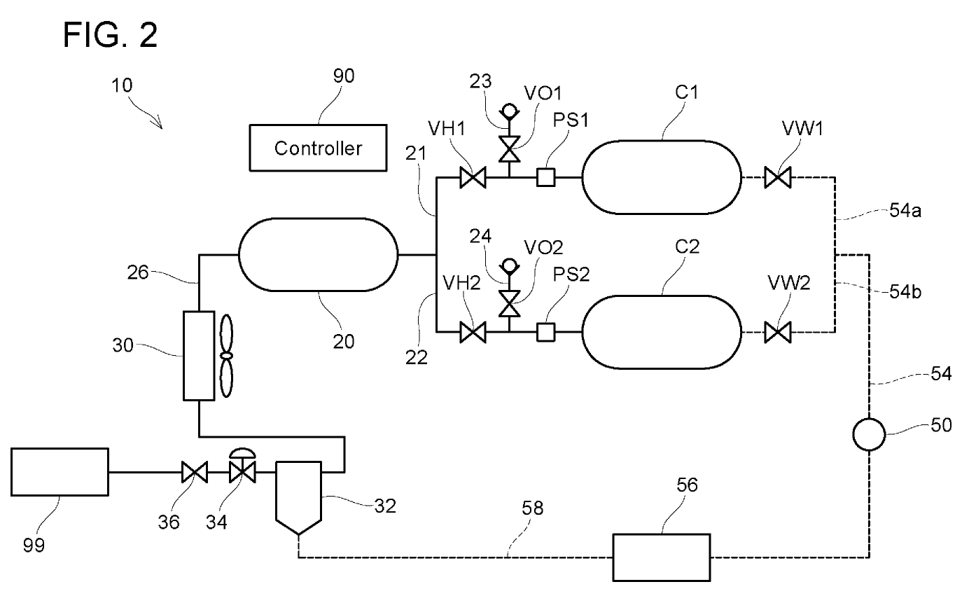

FIG. 2 shows passages for hydrogen gas and water in the hydrogen generating device 10. In FIG. 2, the solid lines indicate the hydrogen gas passages and the dashed lines indicates the water passages.

The hydrogen generating device 10 includes a water tank 56 and a water supply pipe 54. Water (more specifically, pure water) is stored in the water tank 56. The upstream end of the water supply pipe 54 is connected to the water tank 56. A downstream portion of the water supply pipe 54 is branched into two branch pipes 54a and 54b. When the cartridge C1 is attached to the hydrogen generating device 10, the downstream end of the branch pipe 54a is connected to the cartridge C1. When the cartridge C2 is attached to the hydrogen generating device 10, the downstream end of the branch pipe 54b is connected to the cartridge C2. A pump 50 is located at an upstream portion of the water supply pipe 54 (i.e., unbranched portion thereof). The pump 50 pumps water in the water supply pipe 54 to the downstream portion. A valve VW1 configured to open and close the branch pipe 54a is located at the branch pipe 54a. A valve VW2 configured to open and close the branch pipe 54b is located at the branch pipe 54b. The water supply pipe 54 is used to supply water from the water tank 56 to the cartridges C1 and C2. When water flows into the cartridge C1 from the water supply pipe 54, the hydrogen-generating agent reacts with the water in the cartridge C1 and hydrogen gas is thereby generated. When water flows into the cartridge C2 from the water supply pipe 54, the hydrogen-generating agent reacts with the water in the cartridge C2 and hydrogen gas is thereby generated.

The hydrogen generating device 10 includes a first hydrogen supply pipe 21, a second hydrogen supply pipe 22, and a buffer tank 20. When the cartridge C1 is attached to the hydrogen generating device 10, the upstream end of the first hydrogen supply pipe 21 is connected to the cartridge C1. The downstream end of the first hydrogen supply pipe 21 is connected to the buffer tank 20. When the cartridge C2 is attached to the hydrogen generating device 10, the upstream end of the second hydrogen supply pipe 22 is connected to the cartridge C2. The downstream end of the second hydrogen supply pipe 22 is connected to the buffer tank 20. In FIG. 1, the downstream ends of the first hydrogen supply pipe 21 and the second hydrogen supply pipe 22 are joined, but the first hydrogen supply pipe 21 and the second hydrogen supply pipe 22 may be independently connected to the buffer tank 20. The first hydrogen supply pipe 21 is used to supply hydrogen gas from the cartridge C1 to the buffer tank 20. The second hydrogen supply pipe 22 is used to supply hydrogen gas from the cartridge C2 to the buffer tank 20.

A valve VH1 configured to open and close the first hydrogen supply pipe 21 is located at an upstream portion of the first hydrogen supply pipe 21 (i.e., a portion independent of the second hydrogen supply pipe 22). A pressure sensor PS1 is located at a portion of the first hydrogen supply pipe 21 upstream of the valve VH1. The pressure sensor PS1 detects a pressure P1 in the cartridge C1. One end of a purge pipe 23 is connected to the portion of the first hydrogen supply pipe 21 upstream of the valve VH1. The other end of the purge pipe 23 is connected to an element located outside the hydrogen generating device 10 via a check valve. The check valve of the purge pipe 23 permits gas to flow out of the purge pipe 23 to the outside and prohibits gas from flowing into the purge pipe 23 from the outside. When the check valve opens, the cartridge C1 is open to the outside air. A purge valve VO1 configured to open and close the purge pipe 23 is located at the purge pipe 23.

A valve VH2 configured to open and close the second hydrogen supply pipe 22 is located at an upstream portion of the second hydrogen supply pipe 22 (i.e., a portion independent of the first hydrogen supply pipe 21). A pressure sensor PS2 is located at a portion of the second hydrogen supply pipe 22 upstream of the valve VH2. The pressure sensor PS2 detects a pressure P2 in the cartridge C2. One end of a purge pipe 24 is connected to the portion of the second hydrogen supply pipe 22 upstream of the valve VH2. The other end of the purge pipe 24 is connected to an element located outside the hydrogen generating device 10 via a check valve. The check valve of the purge pipe 24 permits gas to flow out of the purge pipe 24 to the outside and prohibits gas from flowing into the purge pipe 24 from the outside. When the check valve opens, the cartridge C2 is open to the outside air. A purge valve VO2 configured to open and close the purge pipe 24 is located at the purge pipe 24.

Hydrogen gas is supplied to the buffer tank 20 from the cartridges C1 and C2. The buffer tank 20 temporarily stores hydrogen gas supplied from the cartridges C1 and C2. The upstream end of a main hydrogen supply pipe 26 is connected to the buffer tank 20. The downstream end of the main hydrogen supply pipe 26 is connected to an external device 99 (e.g., a fuel cell system) located outside the hydrogen generating device 10. The hydrogen gas in the buffer tank 20 is supplied to the external device 99 through the main hydrogen supply pipe 26.

From the upstream end toward the downstream end of the main hydrogen supply pipe 26, a condenser 30, a gas-liquid separator 32, a regulator 34, and a main valve 36 are located in this order along the main hydrogen supply pipe 26. The main valve 36 is configured to open and close the main hydrogen supply pipe 26. When the main valve 36 opens, hydrogen gas is supplied from the buffer tank 20 to the external device 99 through the main hydrogen supply pipe 26.

The condenser 30 cools hydrogen gas in the main hydrogen supply pipe 26 by heat exchange with the outside air. The hydrogen gas generated in the cartridges C1 and C2 contains water vapor. The condenser 30 condenses the water vapor in the hydrogen gas by cooling the hydrogen gas in the main hydrogen supply pipe 26.

The hydrogen gas that flowed through the condenser 30 and liquid water flow into the gas-liquid separator 32. The gas-liquid separator 32 separates the water from the hydrogen gas. The gas-liquid separator 32 is connected to the water tank 56 via a drain pipe 58. The water separated from the hydrogen gas in the gas-liquid separator 32 is returned to the water tank 56 through the drain pipe 58.

The hydrogen gas separated from the water in the gas-liquid separator 32 flows toward the downstream end of the main hydrogen supply pipe 26. The regulator 34 regulates the pressure of hydrogen gas to be supplied to the external device 99.

The hydrogen generating device 10 includes a controller 90. The controller 90 controls the valves VH1, VW1, VO1, VH2, VW2, VO2, the pump 50, and the main valve 36. Detected values at the pressure sensors PS1 and PS2 are input to the controller 90.

Now, how the hydrogen generating device 10 operates to supply hydrogen gas to the external device 99 is described. To supply hydrogen gas to the external device 99, the main valve 36 is controlled to be open. In the following description, the main valve 36 is assumed to be open. The hydrogen generating device 10 is capable of performing a first operation to generate hydrogen gas in the cartridge C1 and a second operation to generate hydrogen gas in the cartridge C2.

In the first operation, the controller 90 controls the valves VH1, VW1, VO1, VH2, VW2, VO2 and the pump 50 as below.

Valve VH1: open

Valve VW1: open

Valve VO1: closed

Valve VH2: closed

Valve VW2: closed

Valve VO2: closed

Pump 50: operating

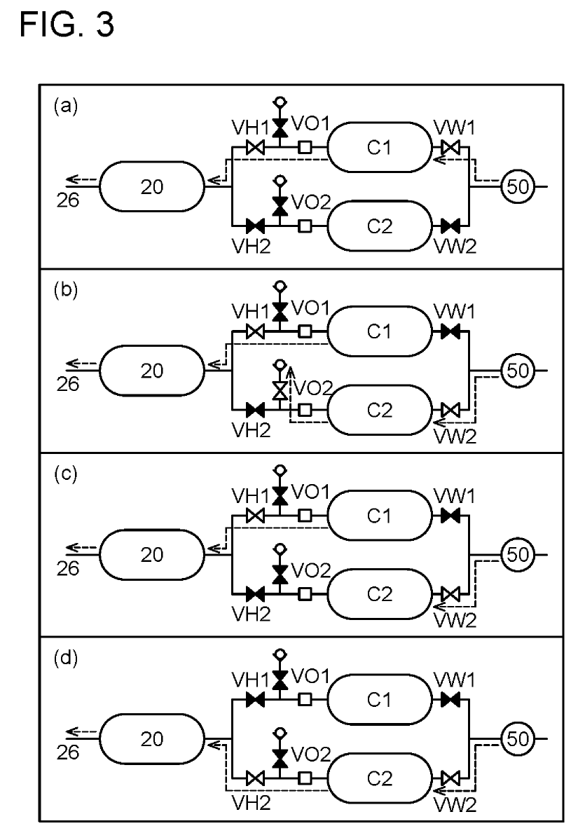

FIG. 3(a) shows the first operation. Since the valve VW2 is closed and the valve VW1 is open in the first operation, water pumped by the pump 50 flows into the cartridge C1 and hydrogen gas is thereby generated in the cartridge C1. Since the valve VH1 is open, the hydrogen gas is supplied from the cartridge C1 to the buffer tank 20. The hydrogen gas in the buffer tank 20 flows into the main hydrogen supply pipe 26 and is supplied to the external device 99. In the first operation, the controller 90 feed-back controls the pump 50 based on the pressure P1 in the cartridge C1 (i.e., a detected value at the pressure sensor PS1). The controller 90 regulates an amount of water supplied to the cartridge C1 by controlling the pump 50 to operate intermittently to maintain the pressure P1 in the cartridge C1 at about 190 kPa. As a result, the pressure of hydrogen gas in the buffer tank 20 is also high.

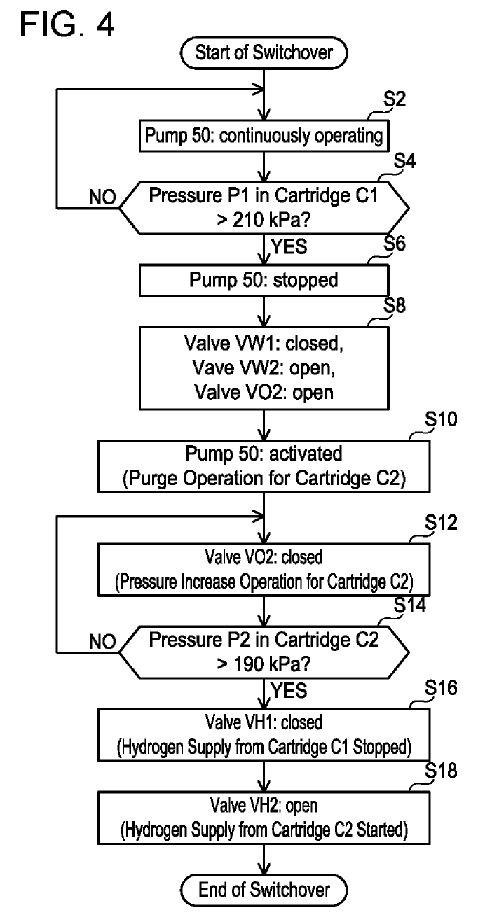

Next, a switching process to switch from the first operation to generate hydrogen gas in the cartridge C1 to the second operation to generate hydrogen gas in the cartridge C2 is described. The flowchart in FIG. 4 shows the switching process. The controller 90 performs the process shown in FIG. 4 when the cartridges should be switched, such as when the usage time of the cartridge C1 exceeds a threshold. The controller 90 is performing the first operation (i.e., FIG. 3(a)) at the start of switching process shown in FIG. 4.

In step S2, the controller 90 controls the pump 50 to continuously operate to increase the amount of water supplied to the cartridge C1. This increases the pressure P1 in the cartridge C1. In step S4, the controller 90 determines whether the pressure P1 in the cartridge C1 exceeds 210 kPa. The controller 90 repeats steps S2 and S4 until the pressure P1 exceeds 210 kPa.

Once the pressure P1 exceeds 210 kPa, the controller 90 temporarily stops the pump 50 in step S6. Then, in step S8, the controller 90 controls the valves as below.

Valve VW1: closed

Valve VW2: open

Valve VO2: open

The states of the other valves are not changed. Then, in step S10, the controller 90 activates the pump 50.

FIG. 3(b) shows the states of respective parts in step S10. Since the valve VW1 is closed, the water supply to the cartridge C1 is stopped. In addition, since the valve VW2 is open, water pumped by the pump 50 flows into the cartridge C2 and hydrogen gas is thereby generated in the cartridge C2. Since the valve VH2 is closed and the purge valve VO2 is open, the gas in the cartridge C2 is released to the outside through the purge valve VO2. The cartridge C2 before use is filled with inert gas (e.g., nitrogen gas). By the cartridge C2 being purged as shown in FIG. 3(b), the inert gas in the cartridge C2 is released to the outside of the hydrogen generating device 10. This prevents the inert gas from flowing into the buffer tank 20 in subsequent steps.

As shown in FIG. 3(b), hydrogen gas flows from the buffer tank 20 to the main hydrogen supply pipe 26 even in step S10 since the pressure in the buffer tank 20 is high. Thus, the supply of hydrogen gas to the main hydrogen supply pipe 26 continues in step S10. Further, as shown in FIG. 3(b), hydrogen gas flows from the cartridge C1 to the buffer tank 20 in step S10 since the valve VH1 is open. In particular, since the pressure in the cartridge C1 has been increased in advance through steps S2 and S4, hydrogen gas flows from the cartridge C1 to the buffer tank 20 even after the supply of water to the cartridge C1 is stopped. This prevents a pressure drop in the buffer tank 20.

After performing the purge operation for the cartridge C2 for a certain period of time in step S10, the controller 90 performs a pressure increase operation in step S12. In step S12, the controller 90 closes the purge valve VO2 but does not change the states of the other valves. FIG. 3(c) shows the states of respective parts in step S12. When the purge valve VO2 is closed, the release of gas from the cartridge C2 to the outside is stopped. Therefore, the pressure P2 in the cartridge C2 increases as hydrogen gas is generated in the cartridge C2. In step S14, the controller 90 determines whether the pressure P2 in the cartridge C2 exceeds 190 kPa. The controller 90 repeats steps S12 and S14 until the pressure P2 exceeds 190 kPa.

As shown in FIG. 3(c), hydrogen gas flows from the buffer tank 20 to the main hydrogen supply pipe 26 even during steps S12 and S14. Thus, the supply of hydrogen gas to the main hydrogen supply pipe 26 continues during steps S12 and S14. Further, as shown in FIG. 3(c), hydrogen gas flows from the cartridge C1 to the buffer tank 20 during steps S12 and S14. This prevents a pressure drop in the buffer tank 20.

Once the pressure P2 exceeds 190 kPa, the controller 90 closes the valve VH1 in step S16 and opens the valve VH2 in step S18. As shown in FIG. 3(d), the supply of hydrogen gas from the cartridge C1 to the buffer tank 20 is stopped due to the closing of the valve VH1, and the supply of hydrogen gas from the cartridge C2 to the buffer tank 20 starts due to the opening of the valve VH2. Since the pressure in the cartridge C2 has been increased to an appropriate value through steps S12 and S14, hydrogen gas is easily supplied from the cartridge C2 to the buffer tank 20. Thus, by performing steps S16 and S18, the supply of hydrogen gas from the cartridge C1 is stopped, and the supply of hydrogen gas from the cartridge C2 starts instead. This completes the switchover from the first operation to generate hydrogen gas in the cartridge C1 to the second operation to generate hydrogen gas in the cartridge C2. In the second operation after the completion of switchover, the controller 90 controls the pump 50 to intermittently operate so that the pressure P2 in the cartridge C2 becomes an appropriate value.

As described above, since the hydrogen generating device 10 according to the first embodiment includes the buffer tank 20, the supply of hydrogen gas to the main hydrogen supply pipe 26 is maintained by the pressure in the buffer tank 20 during the cartridge switching process. Therefore, the switching process can be performed without interrupting the supply of hydrogen gas to the external device 99.

The hydrogen generating device 10 according to the first embodiment performs steps S6 to S14 (i.e., the purging operation for the cartridge C2 and the pressure increase operation) with the valve VH1 opened, and then closes the valve VH1 after the pressure increase operation. Thus, hydrogen gas is supplied from the cartridge C1 to the buffer tank 20 during the purge operation for the cartridge C2 and the pressure increase operation, preventing a pressure drop in the buffer tank 20. Therefore, hydrogen gas can be stably supplied to the external device 99 during the cartridge switching process.

The hydrogen generating device 10 according to the first embodiment increases the pressure in the cartridge C1 by increasing the amount of water supplied to the cartridge C1 in steps S2 and S4 before performing steps S6 to S14 (i.e., the purging operation for the cartridge C2 and pressure increase operation). This more effectively prevents a pressure drop in the buffer tank 20 during the purge operation for the cartridge C2 and pressure increase operation. Therefore, hydrogen gas can be supplied to the external device 99 more stably during the cartridge switching process.

The hydrogen generating device 10 according to the first embodiment performs the purge operation for the cartridge C2 before performing the pressure increase operation. This prevents the inert gas in the cartridge C2 before use from flowing into the buffer tank 20.

In the first embodiment, hydrogen gas is supplied from the cartridge C1 to the buffer tank 20 during the purge operation and the pressure increase operation. However, hydrogen gas may not be supplied from the cartridge C1 to the buffer tank 20 during the purge operation and the pressure increase operation, for example, when a pressure drop in the buffer tank 20 is small.

In the first embodiment, steps S16 and S18 are performed at almost the same time, however, step S16 may be performed before step S18, or step S18 may be performed before step S16.

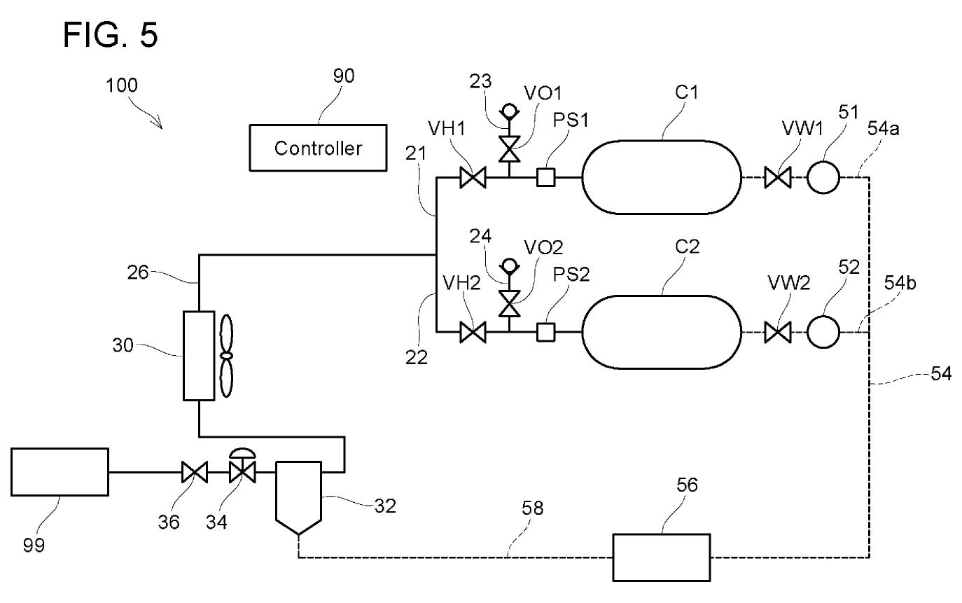

(Second Embodiment) A hydrogen generating device 100 according to a second embodiment shown in FIG. 5 does not include the buffer tank 20. Thus, the downstream ends of the first hydrogen supply pipe 21 and the second hydrogen supply pipe 22 are directly connected to the upstream end of the main hydrogen supply pipe 26. Further, in the hydrogen generating device 100 according to the second embodiment, the pump 50 is not located at the unbranched portion of the water supply pipe 54, a pump 51 is located at the branch pipe 54a, and a pump 52 is located at the branch pipe 54b. The other configurations of the hydrogen generating device 100 according to the second embodiment are the same as those described in connection with the first embodiment.

How the hydrogen generating device 100 operates to supply hydrogen gas to the external device 99 is described. To supply hydrogen gas to the external device 99, the main valve 36 is controlled to be open. In the following description, the main valve 36 is assumed to be open. The hydrogen generating device 100 is capable of performing a first operation to generate hydrogen gas in the cartridge C1 and a second operation to generate hydrogen gas in the cartridge C2.

In the first operation, the controller 90 controls the valves VH1, VW1, VO1, VH2, VW2, VO2 and the pumps 51 and 52 as below.

Valve VH1: open

Valve VW1: open

Valve VO1: closed

Valve VH2: closed

Valve VW2: closed

Valve VO2: closed

Pump 51: operating

Pump 52: stopped

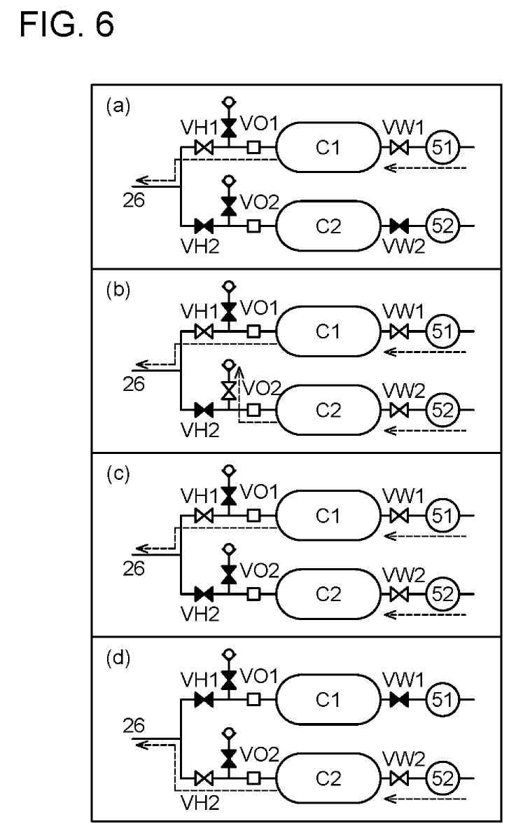

FIG. 6(a) shows the first operation. In the first operation, the supply of water to the cartridge C2 is stopped by the valve VW2 and the pump 52. In contrast, water is supplied to the cartridge C1 since the valve VW1 is open and the pump 51 is operating. As a result, hydrogen gas is generated in the cartridge C1. Since the valve VH1 is open, the hydrogen gas in the cartridge C1 flows into the main hydrogen supply pipe 26 and is supplied to the external device 99. Further, in the first operation, the controller 90 feed-back controls the pump 51 based on the pressure P1 in the cartridge C1 (i.e., a detected value at the pressure sensor PS1). The controller 90 regulates an amount of water to be supplied to the cartridge C1 by controlling the pump 51 to intermittently operate to maintain the pressure P1 in the cartridge C1 at about 190 kPa.

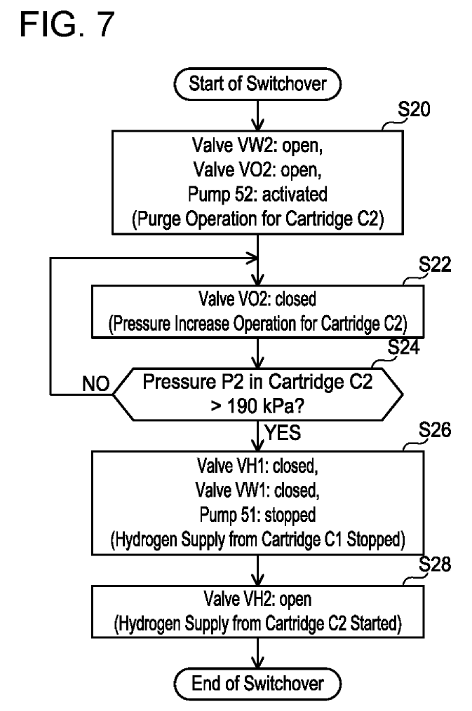

Here, a switching process to switch from the first operation to generate hydrogen gas in the cartridge C1 to the second operation to generate hydrogen gas in the cartridge C2 is described. The flowchart in FIG. 7 shows the switching process. The controller 90 performs the process shown in FIG. 7 when the cartridges should be switched, such as when the usage time of the cartridge C1 exceeds a threshold. The controller 90 is performing the first operation (i.e., FIG. 6(a)) at the start of the switchover shown in FIG. 7.

In step S20, the controller 90 controls the valves and pumps as below.

Valve VW2: open

Valve VO2: open

Pump 52: operating

The states of the other valves and pumps are not changed.

FIG. 6(b) shows the states of respective parts in step S20. Since the pump 52 is operating and the valve VW2 is open, water is supplied to the cartridge C2 and hydrogen gas is thereby generated in the cartridge C2. Since the valve VH2 is closed and the purge valve VO2 is open, the gas in the cartridge C2 is released to the outside of the hydrogen generating device 100 through the purge valve VO2. The cartridge C2 before use is filled with inert gas (e.g., nitrogen gas). By the cartridge C2 being purged as shown in FIG. 6(b), the inert gas in the cartridge C2 is released to the outside. This prevents the inert gas from flowing into the main hydrogen supply pipe 26 in subsequent steps. As shown in FIG. 6(b), since the state of the cartridge C1 is not changed in step S20, the supply of hydrogen gas from the cartridge C1 to the main hydrogen supply pipe 26 continues.

After performing the purge operation for the cartridge C2 for a certain period of time in step S20, the controller 90 performs a pressure increase operation in step S22. In step S22, the controller 90 closes the purge valve VO2 but does not change the states of the other valves and pumps. FIG. 6(c) shows the states of respective parts in step S22. When the purge valve VO2 is closed, the release of gas from the cartridge C2 to the outside is stopped. Therefore, the pressure P2 in the cartridge C2 increases as hydrogen gas is generated in the cartridge C2. In step S24, the controller 90 determines whether the pressure P2 in the cartridge C2 exceeds 190 kPa. The controller 90 repeats steps S22 and S24 until the pressure P2 exceeds 190 kPa.

As shown in FIG. 6(c), since the state of the cartridge C1 is not changed during steps S22 and S24, the supply of hydrogen gas from the cartridge C1 to the main hydrogen supply pipe 26 continues.

Once the pressure P2 exceeds 190 kPa, the controller 90 controls the valves and pumps in step S26 as below.

Valve VH1: closed

Valve VW1: closed

Pump 51: stopped

In addition, the controller 90 opens the valve VH2 in step S28. The states of the other valves and pumps are not changed.

As shown in FIG. 6(d), the supply of water to the cartridge C1 is stopped due to the closing of the valve VW1 and the stop of the pump 51. In addition, the supply of hydrogen gas from the cartridge C1 to the main hydrogen supply pipe 26 stops due to the closing of the valve VH1. Further, the supply of hydrogen gas from the cartridge C2 to the main hydrogen supply pipe 26 starts due to the opening of the valve VH2. Thus, by performing steps S26 and S28, the supply of hydrogen gas from the cartridge C1 is stopped, and the supply of hydrogen gas from the cartridge C2 starts instead. This completes the switchover from the first operation to generate hydrogen gas in the cartridge C1 to the second operation to generate hydrogen gas in the cartridge C2. In the second operation after the completion of switchover, the controller 90 controls the pump 52 to intermittently operate so that the pressure P2 in the cartridge C2 becomes an appropriate value.

As described above, in the hydrogen generating device 100 according to the second embodiment, hydrogen gas is supplied from the cartridge C1 to the main hydrogen supply pipe 26 during the purging operation for the cartridge C2 and the pressure increase operation. Then, once the cartridge C2 is prepared, the supply of hydrogen gas from the cartridge C1 is stopped and the supply of hydrogen gas from the cartridge C2 starts. Thus, the supply of hydrogen gas to the main hydrogen supply pipe 26 is maintained during the cartridge switching process. Therefore, the switching process can be performed without interrupting the supply of hydrogen gas to the external device 99.

The hydrogen generating device 100 according to the second embodiment performs the purge operation before performing the pressure increase operation. This prevents the inert gas in the cartridge C2 before use from flowing into the main hydrogen supply pipe 26.

In the second embodiment, steps S26 and S28 are performed at almost the same time, but step S26 may be performed slightly before step S28, or step S28 may be performed slightly before step S26.

In the first and second embodiments, the switching process from the cartridge C1 to the cartridge C2 is described, however, a switching process from the cartridge C2 to the cartridge C1 can be implemented in the same manner as in the first and second embodiments.

The first slot hole 11 is an example of first attachment portion. The second slot hole 12 is an example of second attachment portion. The valve VH1 is an example of first hydrogen supply valve. The valve VH2 is an example of second hydrogen supply valve. The water supply pipe 54, the pump 50, and the valves VW1 and VW2 in the first embodiment are an example of water supply device. The branch pipe 54a, the pump 51, and the valve VW1 in the second embodiment are an example of first water supply device. The branch pipe 54b, the pump 52, and the valve VW2 in the second embodiment are an example of second water supply device.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A hydrogen generating device, comprising:
a first attachment portion and a second attachment portion to which cartridges are attached, wherein the cartridges contain a substance that generates hydrogen gas when reacting with water;
a water supply device configured to supply water to a first cartridge attached to the first attachment portion and a second cartridge attached to the second attachment portion;
a buffer tank;
a first hydrogen supply passage for supplying hydrogen gas from the first cartridge to the buffer tank;
a second hydrogen supply passage for supplying hydrogen gas from the second cartridge to the buffer tank;
a first hydrogen supply valve configured to open and close the first hydrogen supply passage;
a second hydrogen supply valve configured to open and close the second hydrogen supply passage;
a main hydrogen supply passage for supplying hydrogen gas from the buffer tank to outside; and
a controller configured to control the water supply device, the first hydrogen supply valve, and the second hydrogen supply valve,
for switching a hydrogen supply source from the first cartridge to the second cartridge while hydrogen gas is being supplied from the first cartridge to the buffer tank by water is being supplied to the first cartridge and the first hydrogen supply valve being opened, the controller performs:
a first process to stop supplying water to the first cartridge and supply water to the second cartridge with the second hydrogen supply valve closed, and
a second process to open the second hydrogen supply valve to supply hydrogen gas from the second cartridge to the buffer tank after the first process.

2. The hydrogen generating device of claim 1, wherein the controller performs the first process while keeping the first hydrogen supply valve opened and closes the first hydrogen supply valve after the first process.

3. The hydrogen generating device of claim 2, wherein the controller performs a process to increase an amount of water supplied to the first cartridge to increase a pressure inside the first cartridge before the first process.

4. The hydrogen generating device of claim 1, further comprising a purge valve configured to open and close a flow passage that opens the second cartridge to outside air,
wherein in the first process, the controller opens the purge valve to perform a purge of the second cartridge and closes the purge valve after the purge to increase a pressure inside the second cartridge.

5. A hydrogen generating device, comprising:
a first attachment portion and a second attachment portion to which cartridges are attached, wherein the cartridges contain a substance that generates hydrogen gas when reacting with water;
a first water supply device configured to supply water to a first cartridge attached to the first attachment portion;
a second water supply device configured to supply water to a second cartridge attached to the second attachment portion;
a main hydrogen supply passage for supplying hydrogen gas to outside;
a first hydrogen supply passage for supplying hydrogen gas from the first cartridge to the main hydrogen supply passage;
a second hydrogen supply passage for supplying hydrogen gas from the second cartridge to the main hydrogen supply passage;
a first hydrogen supply valve configured to open and close the first hydrogen supply passage;
a second hydrogen supply valve configured to open and close the second hydrogen supply passage; and
a controller configured to control the first water supply device, the second water supply device, the first hydrogen supply valve, and the second hydrogen supply valve,
for switching a hydrogen supply source from the first cartridge to the second cartridge while hydrogen gas is being supplied from the first cartridge to the main hydrogen supply passage by water is being supplied to the first cartridge and the first hydrogen supply valve being opened, the controller performs:
a first process to supply water to the second cartridge with the second hydrogen supply valve closed while supplying water to the first cartridge and keeping the first hydrogen supply valve opened, and
a second process to open the second hydrogen supply valve to supply hydrogen gas from the second cartridge to the main hydrogen supply passage and close the first hydrogen supply valve after the first process.

6. The hydrogen generating device of claim 5, further comprising a purge valve configured to open and close a flow passage that opens the second cartridge to outside air,
wherein in the first process, the controller opens the purge valve to perform a purge of the second cartridge and closes the purge valve after the purge to increase a pressure inside the second cartridge.
